(19) United States
(12) Patent Application Publication
(10) Pub. No.: US 2026/0101950 A1
(43) Pub. Date: Apr. 16, 2026

(54) HEAD MOUNTED DEVICE AND HEADBAND MODULE

(71) Applicant: HTC Corporation, Taoyuan City (TW)

(72) Inventors: Li-Hsun Chang, Taoyuan City (TW); Kuan-Ying Ou, Taoyuan City (TW); Yu-Hsun Chung, Taoyuan City (TW)

(73) Assignee: HTC Corporation, Taoyuan City (TW)

(21) Appl. No.: 19/174,932

(22) Filed: Apr. 10, 2025

Related U.S. Application Data
(60) Provisional application No. 63/708,245, filed on Oct. 16, 2024.
(60) Provisional application No. 63/718,742, filed on Nov. 11, 2024.

(51) Int. Cl. A42B 1/22

(52) U.S. Cl. CPC A42B 1/22

(57) ABSTRACT

A head mounted device, and a headband module including housing, band body, rotating component, braking component, restoring component, driving component. Two adjustment sections of band body at least partially overlap and are movably disposed in housing. The rotating component is rotatably arranged on housing around a rotation axis and is coupled to two adjusting sections. The braking component is disposed on housing and may translate along rotation axis. When rotating component is engaged with braking component, the rotating component is only allowed to rotate in a single direction around rotation axis. The restoring component is arranged between housing and braking component and provides elastic restoring force to maintain engagement between rotating component and braking component. The driving component and host are connected through housing. The driving component is configured to drive braking component to move in direction away from rotating component to release engagement between rotating component and braking component.

### CROSS-REFERENCE TO RELATED APPLICATION

This application claims the priority benefit of U.S. provisional application Ser. No. 63/708,245, filed on Oct. 16, 2024, and U.S. provisional application Ser. No. 63/718,742, filed on Nov. 11, 2024. The entirety of each of the above-mentioned patent applications is hereby incorporated by reference herein and made a part of this specification.

### Technical Field

This application relates to a device and a module, and particularly relates to a head mounted device and a headband module.

### Related Art

With the increasing development of the technology industry, the types, functions, and methods of display devices are becoming more diverse, and head mounted display devices that may be directly worn on the head of the user have emerged accordingly. After the user wears the head mounted display device, in addition to seeing three-dimensional images, the images also change with the rotation of the head of the user, which may provide the user with a more immersive experience.

However, different users have different head circumferences, and a headband module with adjustable length is needed to accommodate different users. Currently, the length of the headband module is generally adjusted through a knob to adjust the degree of tightness. Users spend more time rotating the knob to loosen the headband module before wearing, and then spend time again rotating the knob to shorten the length of the headband module and adjust the tightness. At the same time, to take off the head mounted display device, it also takes more time to rotate the knob to loosen the headband module.

### SUMMARY

This application provides a head mounted device and a headband module, to provide a simple and intuitive wearing method.

The head mounted device of this application includes a host and a headband module. The headband module includes a housing, a band body, a rotating component, a braking component, a restoring component, and a driving component. The band body has a first adjustment section and a second adjustment section located at opposite ends, and is configured to surround the head of a user. The first adjustment section and the second adjustment section at least partially overlap and are movably disposed in the housing. The rotating component is rotatably arranged on the housing around a rotation axis and has a coupled portion and a first ratchet facing portion. The coupled portion couples the first adjustment section and the second adjustment section, so that the first adjustment section and the second adjustment section move synchronously with respect to the housing. The braking component is disposed on the housing and may translate along the rotation axis, and has a second ratchet facing portion. When the second ratchet facing portion and the first ratchet facing portion are engaged, the rotating component is allowed to rotate with respect to the housing in a first clockwise direction around the rotation axis, and limits the rotating component to rotate with respect to the housing in a second clockwise direction around the rotation axis. The second clockwise direction is opposite to the first clockwise direction. The restoring component is arranged between the housing and the braking component and provides elastic restoring force to maintain the engagement between the second ratchet facing portion and the first ratchet facing portion. The driving component is movably disposed on the housing. The driving component and the host are connected to each other through the housing. The driving component is configured to drive the braking component to move in a direction away from the rotating component so as to release the engagement between the first ratchet facing portion and the second ratchet facing portion.

The headband module of this application is adapted for a head mounted device. The head mounted device includes a host. The headband module includes a housing, a band body, a rotating component, a braking component, a restoring component, and a driving component. The band body has a first adjustment section and a second adjustment section located at opposite ends, and is configured to surround the head of a user. The first adjustment section and the second adjustment section at least partially overlap and are movably disposed in the housing. The rotating component is rotatably arranged on the housing around a rotation axis and has a coupled portion and a first ratchet facing portion. The coupled portion couples the first adjustment section and the second adjustment section, so that the first adjustment section and the second adjustment section move synchronously with respect to the housing. The braking component is disposed on the housing and may translate along the rotation axis, and has a second ratchet facing portion. When the second ratchet facing portion and the first ratchet facing portion are engaged, the rotating component is allowed to rotate with respect to the housing in a first clockwise direction around the rotation axis, and limits the rotating component to rotate with respect to the housing in a second clockwise direction around the rotation axis. The second clockwise direction is opposite to the first clockwise direction. The restoring component is arranged between the housing and the braking component and provides elastic restoring force to maintain the engagement between the second ratchet facing portion and the first ratchet facing portion. The driving component is movably disposed on the housing. The driving component and the host are connected to each other through the housing. The driving component is configured to drive the braking component to move in a direction away from the rotating component so as to release the engagement between the first ratchet facing portion and the second ratchet facing portion.

Based on the above, in the head mounted device and the headband module of this application, the length of the headband module may be directly adjusted and locked, and when taking off, force may be directly applied to the driving component connected to the host to release the headband module, providing a simple and intuitive wearing method.

### BRIEF DESCRIPTION OF THE DRAWINGS

FIG. 1 is a schematic view of a use status of a head mounted device according to an embodiment of the present invention.

FIG. 2 is an exploded schematic view of a headband module of the head mounted device in FIG. 1.

FIG. 3 and FIG. 4 are partial sectional views of another cross-section of the headband module of the head mounted device in FIG. 1 in two different statuses.

FIG. 5 is a partial perspective view of the headband module of the head mounted device in FIG. 1.

FIG. 6 is a partial sectional view of the headband module of the head mounted device in FIG. 5.

FIG. 7 is a partial schematic view of the head mounted device according to another embodiment of the present invention.

FIG. 8 is a partial perspective view of the headband module of the head mounted device in FIG. 7.

FIG. 9 is a schematic view of the head mounted device according to yet another embodiment of the present invention.

FIG. 10 is a schematic view of the head mounted device according to still another embodiment of the present invention.

### DESCRIPTION OF THE EMBODIMENTS

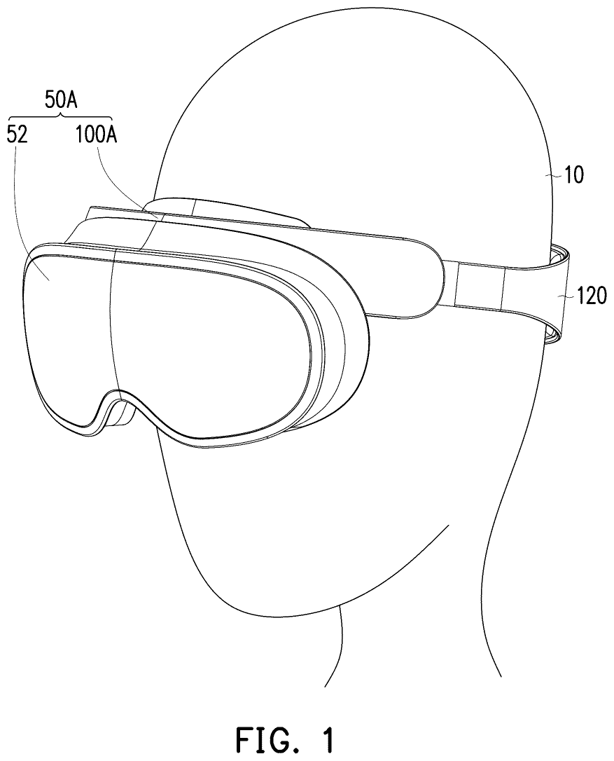

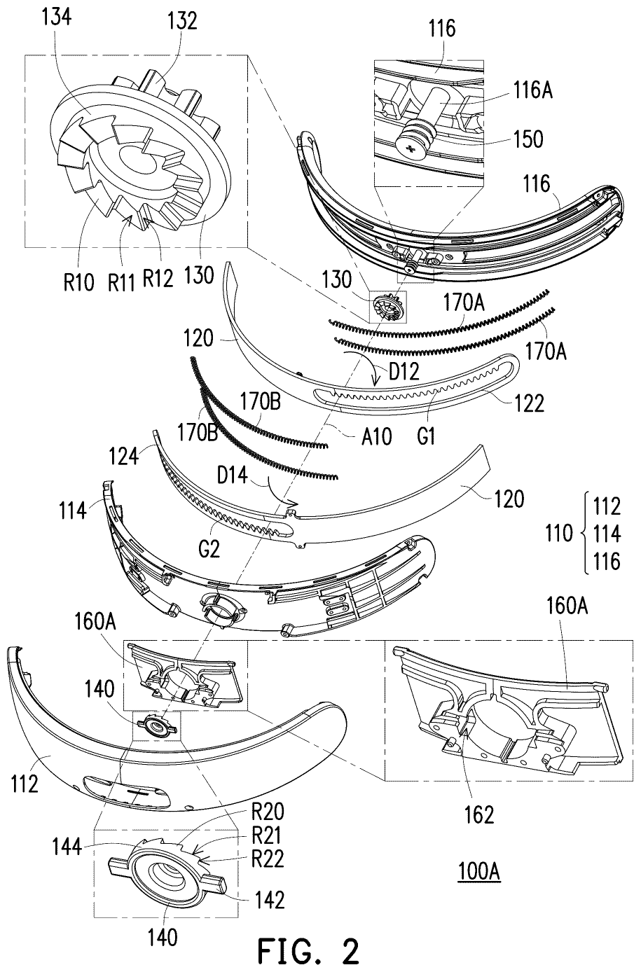

FIG. 1 is a schematic view of a use status of a head mounted device according to an embodiment of the present invention. FIG. 2 is an exploded schematic view of a headband module of the head mounted device in FIG. 1. FIG. 2 includes enlarged views of partial areas and partial components. Referring to FIG. 1 and FIG. 2, a head mounted device 50A of this embodiment includes a host 52 and a headband module 100A. The host 52 may be a head mounted display, which may be applied in fields such as virtual reality system, augmented reality system, or mixed reality system. The host 52 may include components such as an optical system and a protective housing, and may dispose a display or be adapted for placing a display. The display may be a built-in display or an added portable display (such as a smartphone), but the present application is not limited thereto. The optical system includes optical components configured to change the optical path of the display, such as lens components, light guide members, or prisms. In other embodiments, the host 52 may also be other devices that do not have display function but need to be worn on the head of the user, such as a headlamp or other devices.

The headband module 100A of this embodiment includes a housing 110, a band body 120, a rotating component 130, a braking component 140, a restoring component 150, and a driving component 160A. The band body 120 has a first adjustment section 122 and a second adjustment section 124 located at opposite ends, and is configured to surround a head 10 of a user. Specifically, the band body 120 of this embodiment is a strip-shaped band body, in order to stably secure the host 52 on the head 10 of the user. After the band body 120 surrounds the head 10 of the user, the first adjustment section 122 and the second adjustment section 124 located at opposite ends partially overlap. In addition, the at least partially overlapped portions of the first adjustment section 122 and the second adjustment section 124 are movably disposed inside the housing 110. Therefore, the user may allow more portions of the band body 120 to be retracted into the housing 110, or pull out some portions of the band body 120 from inside the housing 110, so as to accommodate different sizes of the heads 10 of different users.

The rotating component 130 is rotatably arranged on the housing 110 around a rotation axis A10 and has a coupled portion 132 and a first ratchet facing portion 134. The coupled portion 132 couples the first adjustment section 122 and the second adjustment section 124, so that the first adjustment section 122 and the second adjustment section 124 move synchronously with respect to the housing 110. The coupled portion 132 may be a gear that engages with a first rack G1 of the first adjustment section 122 and a second rack G2 of the second adjustment section 124 respectively, but the present application is not limited thereto. Since the rotating component 130 only rotates around the rotation axis A10 on the housing 110 without displacement with respect to the rotation axis A10, when the first adjustment section 122 moves a certain distance in one direction with respect to the rotating component 130, the second adjustment section 124 also moves the same distance in the opposite direction with respect to the rotating component 130. In this way, it can be ensured that the overlapped portions of the first adjustment section 122 and the second adjustment section 124 remain inside the housing 110.

The braking component 140 is disposed on the housing 110 and may translate along the rotation axis A10, and has a second ratchet facing portion 144. In this embodiment, the first ratchet facing portion 134 includes, for example, multiple first ratchets R10, which are arranged in a circular pattern around the rotation axis A10 on the rotating component 130. Each first ratchet R10 has a first inclined surface R11 and a first stopper surface R12 on two sides respectively. The first stopper surfaces R12 are nearly vertical surfaces. The second ratchet facing portion 144 includes, for example, multiple second ratchets R20, which are arranged in a circular pattern around the rotation axis A10 on the braking component 140. Each second ratchet R20 has a second inclined surface R21 and a second stopper surface R22 on two sides respectively. The second stopper surfaces R22 are nearly vertical surfaces.

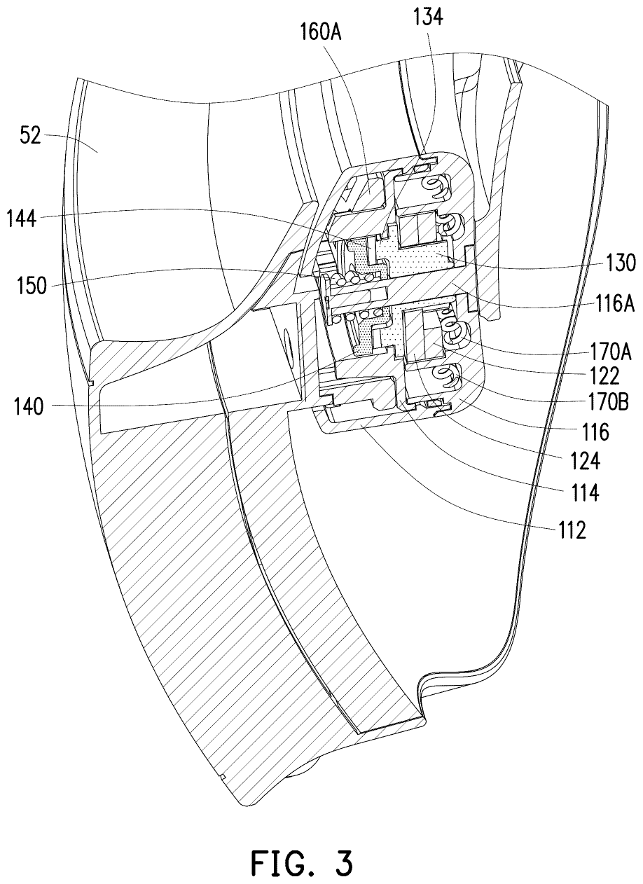

FIG. 3 is a partial cross-sectional view of another cross-section of the headband module of the head mounted device in FIG. 1 when the first ratchet facing portion and the second ratchet facing portion are engaged with each other. Referring to FIG. 2 and FIG. 3, when the first ratchet facing portion 134 and the second ratchet facing portion 144 are engaged with each other, the braking component 140 blocks the rotating component 130 through structural interference between the first stopper surfaces R12 and the second stopper surfaces R22, so as to limit the rotation of the rotating component 130 with respect to the bracket 110 in a second clockwise direction D14 around the rotation axis A10.

When the first ratchet facing portion 134 and the second ratchet facing portion 144 are engaged with each other, since the first inclined surface R11 and the second inclined surface R21 may slide with respect to each other, the rotating component 130 may be allowed to rotate with respect to the housing 110 in a first clockwise direction D12 around the rotation axis A10. When the rotating component 130 rotates, component force of force applied by the first ratchet facing portion 134 to the second ratchet facing portion 144 pushes the braking component 140 in a direction away from the rotating component 130. If the user wants to further increase the wearing tightness of the head mounted device 50A, the user only needs to press the host 52 and the band body 120 at the back of the head simultaneously, so that more portions of the band body 120 are retracted into the housing 110, achieving the purpose of stable wearing, which is very convenient. At this time, the first rack G1 of the first adjustment section 122 and the second rack G2 of the second adjustment section 124 also drive the rotating component 130 to rotate with respect to the housing 110 in the first clockwise direction D12 around the rotation axis A10. Moreover, the braking component 140 does not prevent the rotating component 130 from rotating in the first clockwise direction D12, thus the wearing size of the head mounted device 50A may be reduced.

In this embodiment, the restoring component 150 is arranged between the housing 110 and the braking component 140 and provides elastic restoring force to maintain the engagement between the second ratchet facing portion 144 and the first ratchet facing portion 134. That is, although during the process of increasing the overlapped portions of the first adjustment section 122 and the second adjustment section 124, the rotating component 130 rotating in the first clockwise direction D12 pushes the braking component 140 away, but as long as the currently abutting first ratchet R10 and second ratchet R20 become misaligned with rotation, the elastic restoring force of the restoring component 150 may push the braking component 140 back to the position where the second ratchet facing portion 144 and the first ratchet facing portion 134 are engaged with each other. Therefore, even if the user no longer pushes the band body 120 and the host 52, the rotating component 130 is braked by the braking component 140, limiting the rotation of the rotating component 130 in the second clockwise direction D14, which prevents the overlapped portions of the first adjustment section 122 and the second adjustment section 124 from changing, locking the wearing size of the head mounted device 50A. The restoring component 150 in this embodiment is, for example, a spring, but the present application is not limited thereto. In another embodiment not shown, the restoring component 150 may also include at least one pair of permanent magnets that may generate magnetic attraction or magnetic repulsion.

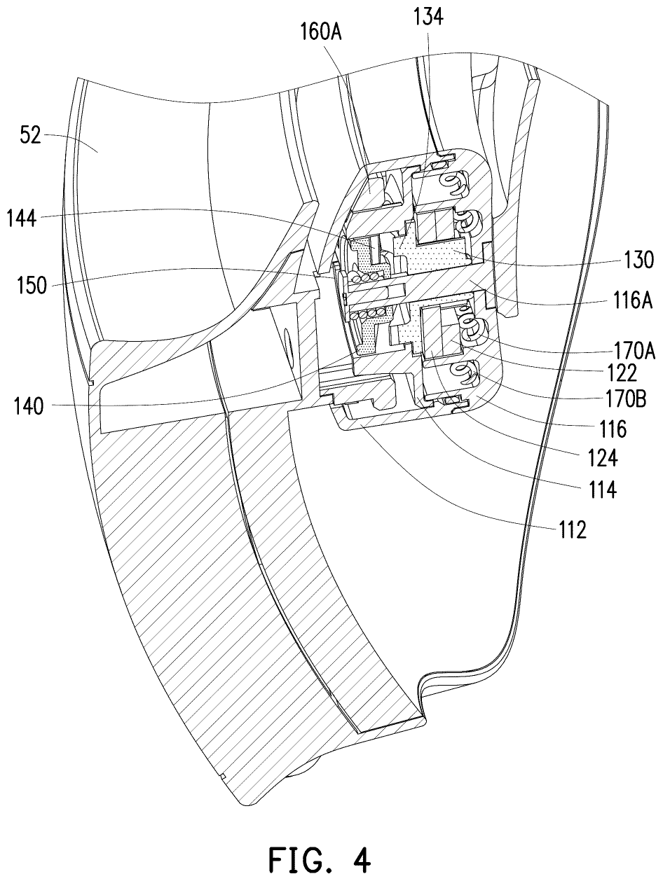

FIG. 4 is a partial sectional view of another cross-section of the headband module of the head mounted device in FIG. 1 when the first ratchet facing portion and the second ratchet facing portion are separated from each other. Referring to FIG. 3 and FIG. 4, the driving component 160A is movably disposed in the housing 110. The driving component 160A is connected to the host 52 through the housing 110. That is, when the host 52 moves with respect to the housing 110, the driving component 160A is also driven synchronously to move with respect to the housing 110. The driving component 160A is configured to drive the braking component 140 to move in a direction away from the rotating component 130 so as to release the engagement between the first ratchet facing portion 134 and the second ratchet facing portion 144. For example, the braking component 140 of this embodiment has two rods 142 on both sides, and the driving component 160A has two slots 162 for accommodating the two rods 142. When the driving component 160A is driven by the host 52 to move in a direction away from the housing 110, the driving component 160A also drives the braking component 140 in a direction away from the housing 110 through the cooperation of the rods 142 and the slots 162, so that the first ratchet facing portion 134 and the second ratchet facing portion 144 are no longer engaged. Therefore, the rotating component 130 is no longer braked by the braking component 140 and may rotate in the second clockwise direction D14, that is, the overlapped portions of the first adjustment section 122 and the second adjustment section 124 may be shortened, the wearing size of the head mounted device 50A may be enlarged, allowing the user to remove the head mounted device 50A from the head 10. In other words, when the user wants to take off the head mounted device 50A, the operation merely requires to intuitively grab the host 52 and make it move away from the head 10, and the operation of removing the head mounted device 50A can be successfully done, which is very convenient.

Referring to FIG. 2 and FIG. 3, in this embodiment, the headband module 100A further includes a first elastic member 170A and a second elastic member 170B. The first elastic member 170A is disposed between the housing 110 and the first adjustment section 122. The second elastic member 170B is disposed between the housing 110 and the second adjustment section 124. The first elastic member 170A and the second elastic member 170B respectively drive the first adjustment section 122 and the second adjustment section 124 to move with respect to the housing 110, so as to increase the degree of overlap between the first adjustment section 122 and the second adjustment section 124. The first elastic member 170A and the second elastic member 170B may be, for example, springs, elastic bands, elastic rubber members, but the present application is not limited thereto.

When the user wishes to wear the head mounted device 50A, one hand may grab the host 52 and pull it forward, the pulled driving component 160A may drive the braking component 140 to release the engagement between the braking component 140 and the rotating component 130. Thus, the first adjustment section 122 and the second adjustment section 124 may be allowed to move freely with respect to the housing 110, thereby increasing the length of the headband module 100A, to facilitate putting the head mounted device 50A on the head 10 of the user. After the user releases their hand, under the action of the first elastic member 170A and the second elastic member 170B, the wearing size of the head mounted device 50A is automatically reduced to be adapted to the head 10 of the user. At the same time, under the action of the restoring component 150, the engagement between the braking component 140 and the rotating component 130 is automatically restored to limit the wearing size of the head mounted device 50A from enlarging and causing loosening. To further increase the wearing tightness of the head mounted device 50A, the host 52 and the band body 120 at the rear head position are simultaneously pressed, so that more portions of the band body 120 are retracted into the housing 110, so as to further reduce the wearing size of the head mounted device 50A.

In this embodiment, the housing 110 includes a front member 112, a middle member 114, and a rear member 116. The middle member 114 is assembled between the front member 112 and the rear member 116. The first adjustment section 122, the second adjustment section 124, the first elastic member 170A, and the second elastic member 170B are located between the middle member 114 and the rear member 116. The driving component 160A is located between the middle member 114 and the front member 112. The rear member 116 has a limiting shaft 116A at a position on the rotation axis A10. The limiting shaft 116A passes through the rotating component 130, the restoring component 150, and the braking component 140. Two ends of the restoring component 150 are respectively abutted against the braking component 140 and the end of the limiting shaft 116A, so as to apply the elastic restoring force to the braking component 140 when the braking component 140 moves toward the end of the limiting shaft 116A, causing it to maintain a tendency to move toward the rotating component 130.

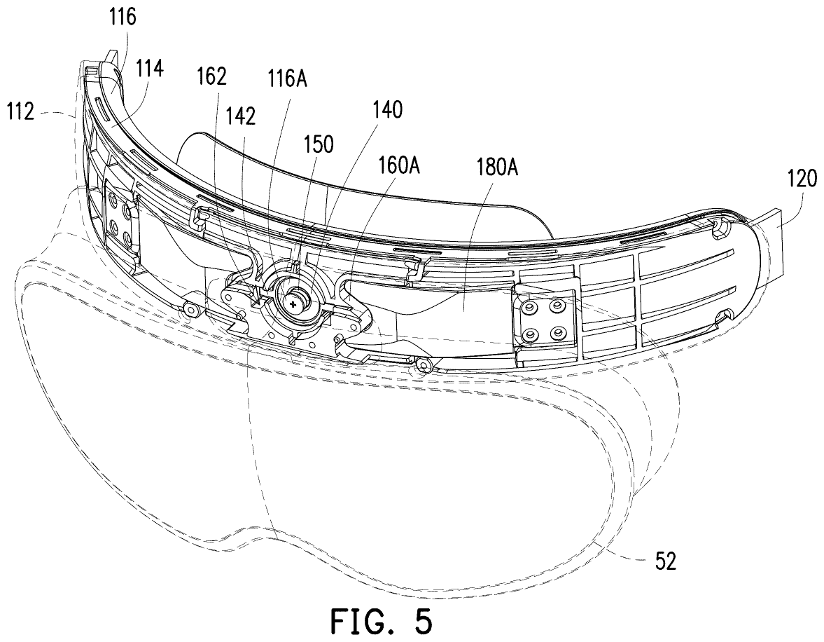

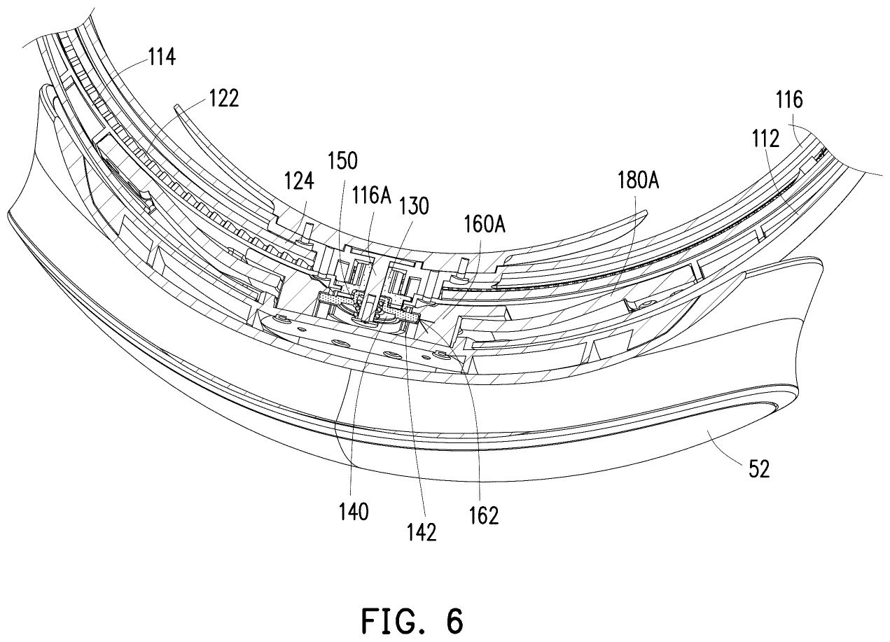

FIG. 5 is a partial perspective view of the headband module of the head mounted device in FIG. 1. FIG. 6 is a partial cross-sectional view of the headband module of the head mounted device in FIG. 1. Referring to FIG. 5 and FIG. 6, in this embodiment, the headband module 100A further includes a spring piece 180A (not shown in FIG. 2), disposed in the housing 110 and configured to provide the elastic restoring force to maintain the position of the driving component 160A so that the second ratchet facing portion 144 and the first ratchet facing portion 134 may be engaged. When the user no longer applies pulling force to pull the host 52 and the driving component 160A forward, the elastic restoring force of the spring piece 180A may pull the driving component 160A back to original position, allowing the braking component 140 and the rotating component 130 to be engaged again.

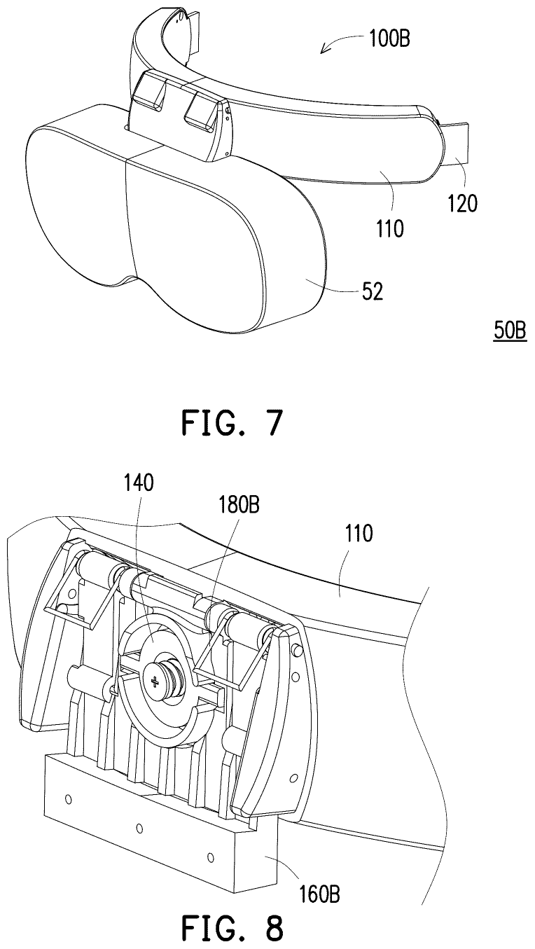

FIG. 7 is a partial schematic view of the head mounted device according to another embodiment of the present invention. FIG. 8 is a partial perspective view of the headband module of the head mounted device in FIG. 7. Referring to FIG. 7 and FIG. 8, a head mounted device 50B of this embodiment is substantially the same as the head mounted device 50A in FIG. 1, except that the headband module 100B of the head mounted device 50B of this embodiment further includes a torsion spring 180B, while the spring piece 180A is not included. For the same components of the head mounted device 50B of this embodiment and the head mounted device 50A in FIG. 1, please refer to FIG. 2. The driving component 160B is pivotally connected to the housing 110. The torsion spring 180B is disposed at the pivotal connection between the driving component 160B and the housing 110 and is configured to provide the elastic restoring force to maintain the position of the driving component 160B, so that the second ratchet facing portion 144 and the first ratchet facing portion 134 may be engaged. When the user wants to take off the head mounted device 50B, the habitual action of grabbing the host 52 is usually forward and upward, similar to a flipping-up motion. Following the motion of the user, the driving component 160B of this embodiment is disposed in a manner pivotally connected to the housing 110. When the driving component 160B rotates upward with the host 52, the operation still drives the braking component 140 away from the rotating component 130, thereby releasing the engagement between the braking component 140 and the rotating component 130, allowing the length of the headband module 100B to increase, making it easier for the user to take off the head mounted device 50B. Moreover, when the user no longer grabs the host 52, the elastic restoring force applied to the driving component 160B by the torsion spring 180B may rotate the driving component 160B back to the original position, allowing the braking component 140 and the rotating component 130 to be engaged again.

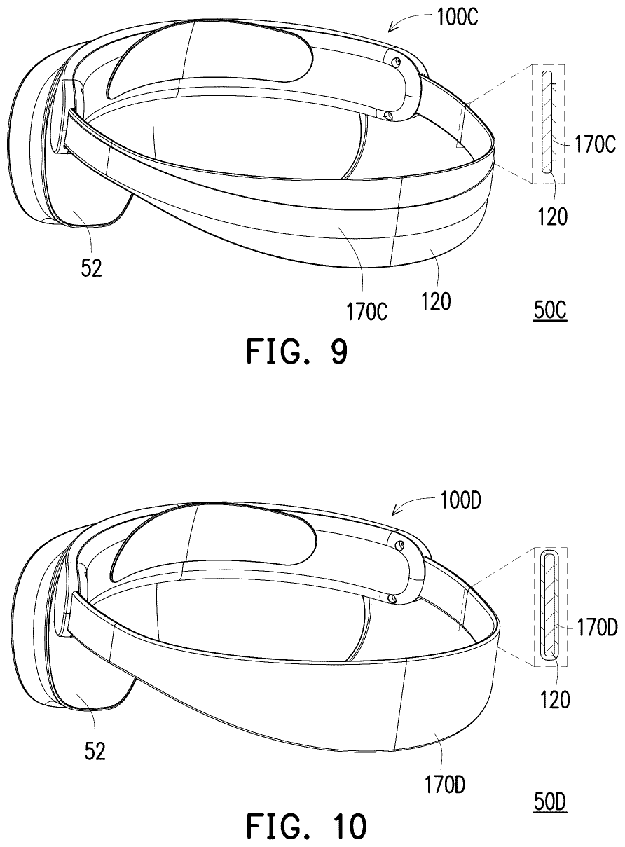

FIG. 9 is a schematic view of the head mounted device according to yet another embodiment of the present invention. FIG. 9 includes an enlarged cross-sectional view of a partial area. Referring to FIG. 9, a head mounted device 50C of this embodiment is substantially the same as the head mounted device 50A in FIG. 1, except that the headband module 100C of the head mounted device 50C of this embodiment further includes an elastic band 170C, while the first elastic member 170A and the second elastic member 170B are not included. For the same components of the head mounted device 50C of this embodiment and the head mounted device 50A in FIG. 1, please refer to FIG. 2. Two ends of the elastic band 170C are connected to two ends of the housing 110. The elastic band 170C is configured to surround the head 10 of the user, and the band body 120 is located between the elastic band 170C and the head 10 of the user (please refer to FIG. 1). That is, both the band body 120 and the elastic band 170C surround the head 10 of the user, and the elastic band 170C also surrounds the band body 120, as shown in the enlarged cross-sectional view of the partial area in FIG. 9. The elastic band 170C drives the first adjustment section 122 and the second adjustment section 124 to move with respect to the housing 110, so as to increase the degree of overlap between the first adjustment section 122 and the second adjustment section 124. That is, the elastic restoring force of the elastic band 170C keeps the band body 120 in a tendency to have more portions to be retracted into the housing 110. When the user wears the head mounted device 50C on the head 10 of the user and releases it, under the action of the elastic band 170C, the wearing size of the head mounted device 50C is automatically reduced to be adapted to the size of the head 10 of the user. The two ends of the elastic band 170C may be connected to two ends of the front member 112 of the housing 110 or two ends of the middle member 114 as shown in FIG. 2, but the present application is not limited thereto.

FIG. 10 is a schematic view of the head mounted device according to still another embodiment of the present invention. FIG. 10 includes an enlarged cross-sectional view of a partial area. Referring to FIG. 9 and FIG. 10, a head mounted device 50D of this embodiment is substantially the same as the head mounted device 50C in FIG. 9, except that the elastic band 170D of the headband module 100D of the head mounted device 50D of this embodiment covers the band body 120, as shown in the enlarged cross-sectional view of the partial area in FIG. 10. Therefore, the elastic band 170D may provide greater elastic restoring force, and is not easily separated from the band body 120.

In summary, in the head mounted device and headband module of the present application, the user may directly pull the headband module to increase the length of the headband module and wear the head mounted device on the head. Then, by simply pressing both the host and the band body at the back of the head simultaneously, more portions of the band body are retracted into the housing to secure the head mounted device on the head. Moreover, by directly pulling the host, the device can be unlocked and easily removed. Therefore, the user may wear the head mounted device and headband module of the present application in a simple and intuitive method. In other words, compared with the known method of adjusting the length of the headband module through a knob, the present application allows adjustment of the headband length by directly applying force to the host and the band body at the back of the head, and has a more streamlined product appearance.

1. A head mounted device, comprising:
a host; and
a headband module, comprising:
a housing;
a band body having a first adjustment section and a second adjustment section located at opposite ends, and configured to surround a head of a user, wherein the first adjustment section and the second adjustment section at least partially overlap and are movably disposed in the housing;
a rotating component rotatably arranged on the housing around a rotation axis and having a coupled portion and a first ratchet facing portion, wherein the coupled portion couples the first adjustment section and the second adjustment section, so that the first adjustment section and the second adjustment section move synchronously with respect to the housing;
a braking component disposed on the housing and translatable along the rotation axis, and having a second ratchet facing portion, wherein in response to the second ratchet facing portion and the first ratchet facing portion being engaged, the rotating component is allowed to rotate with respect to the housing in a first clockwise direction around the rotation axis, and limits the rotating component to rotate with respect to the housing in a second clockwise direction around the rotation axis, wherein the second clockwise direction is opposite to the first clockwise direction;
a restoring component arranged between the housing and the braking component and providing elastic restoring force to maintain engagement between the second ratchet facing portion and the first ratchet facing portion; and
a driving component movably disposed on the housing, wherein the driving component and the host are connected to each other through the housing, the driving component is configured to drive the braking component to move in a direction away from the rotating component so as to release the engagement between the first ratchet facing portion and the second ratchet facing portion.

2. The head mounted device as claimed in claim 1, wherein the headband module further comprises a first elastic member and a second elastic member, the first elastic member is disposed between the housing and the first adjustment section, the second elastic member is disposed between the housing and the second adjustment section, and the first elastic member and the second elastic member respectively drive the first adjustment section and the second adjustment section to move with respect to the housing, so as to increase a degree of overlap between the first adjustment section and the second adjustment section.

3. The head mounted device as claimed in claim 1, wherein the headband module further comprises an elastic band, two ends of the elastic band are connected to two ends of the housing, the elastic band is configured to surround the head of the user, the band body is located between the elastic band and the head of the user, and the elastic band drives the first adjustment section and the second adjustment section to move with respect to the housing, so as to increase a degree of overlap between the first adjustment section and the second adjustment section.

4. The head mounted device as claimed in claim 3, wherein the elastic band covers the band body.

5. The head mounted device as claimed in claim 1, wherein the headband module further comprises a spring piece disposed in the housing and configured to provide the elastic restoring force to maintain a position of the driving component so that the second ratchet facing portion and the first ratchet facing portion are engaged.

6. The head mounted device as claimed in claim 1, wherein the headband module further comprises a torsion spring, the driving component is pivotally connected to the housing, and the torsion spring is disposed at a pivotal connection between the driving component and the housing and is configured to provide the elastic restoring force to maintain a position of the driving component so that the second ratchet facing portion and the first ratchet facing portion are engaged.

7. A headband module adapted for a head mounted device, wherein the head mounted device comprises a host, and the headband module comprises:
a housing;
a band body having a first adjustment section and a second adjustment section located at opposite ends, and configured to surround a head of a user, wherein the first adjustment section and the second adjustment section at least partially overlap and are movably disposed in the housing;
a rotating component rotatably arranged on the housing around a rotation axis and having a coupled portion and a first ratchet facing portion, wherein the coupled portion couples the first adjustment section and the second adjustment section, so that the first adjustment section and the second adjustment section move synchronously with respect to the housing;
a braking component disposed on the housing and translatable along the rotation axis, and having a second ratchet facing portion, wherein in response to the second ratchet facing portion and the first ratchet facing portion being engaged, the rotating component is allowed to rotate with respect to the housing in a first clockwise direction around the rotation axis, and limits the rotating component to rotate with respect to the housing in a second clockwise direction around the rotation axis, wherein second clockwise direction is opposite to the first clockwise direction;
a restoring component arranged between the housing and the braking component and providing elastic restoring force to maintain engagement between the second ratchet facing portion and the first ratchet facing portion; and
a driving component movably disposed on the housing, wherein the driving component and the host are connected to each other through the housing, and the driving component is configured to drive the braking component to move in a direction away from the rotating component so as to release the engagement between the first ratchet facing portion and the second ratchet facing portion.

8. The headband module as claimed in claim 7, further comprising a first elastic member and a second elastic member, wherein the first elastic member is disposed between the housing and the first adjustment section, the second elastic member is disposed between the housing and the second adjustment section, and the first elastic member and the second elastic member respectively drive the first adjustment section and the second adjustment section to move with respect to the housing, so as to increase a degree of overlap between the first adjustment section and the second adjustment section.

9. The headband module as claimed in claim 7, further comprising an elastic band, wherein two ends of the elastic band are connected to two ends of the housing, the elastic band is configured to surround the head of the user, the band body is located between the elastic band and the head of the user, and the elastic band drives the first adjustment section and the second adjustment section to move with respect to the housing, so as to increase a degree of overlap between the first adjustment section and the second adjustment section.

10. The headband module as claimed in claim 9, wherein the elastic band covers the band body.

11. The headband module as claimed in claim 7, further comprising a spring piece disposed in the housing and configured to provide the elastic restoring force to maintain a position of the driving component so that the second ratchet facing portion and the first ratchet facing portion are engaged.

12. The headband module as claimed in claim 7, further comprising a torsion spring, wherein the driving component is pivotally connected to the housing, and the torsion spring is disposed at a pivotal connection between the driving component and the housing and is configured to provide the elastic restoring force to maintain a position of the driving component so that the second ratchet facing portion and the first ratchet facing portion are engaged.
